(19) United States
(12) Patent Application Publication
(10) Pub. No.: US 2018/0053531 A1
(43) Pub. Date: Feb. 22, 2018

(54) REAL TIME VIDEO PERFORMANCE INSTRUMENT

(71) Applicant: Bryan Joseph Wrzesinski, Los Angeles, CA (US)

(72) Inventor: Bryan Joseph Wrzesinski, Los Angeles, CA (US)

(21) Appl. No.: 15/677,025

(22) Filed: Aug. 15, 2017

Related U.S. Application Data
(60) Provisional application No. 62/376,708, filed on Aug. 18, 2016.
(60) Provisional application No. 62/442,979, filed on Jan. 6, 2017.

(51) Int. Cl. G11B 27/036; H04N 21/472; G11B 27/34; H04N 5/92; H04N 21/2343; H04N 21/2743

(52) U.S. Cl. CPC G11B 27/036; H04N 21/47205; H04N 21/2743; H04N 5/9202; H04N 21/234372; G11B 27/34

(57) ABSTRACT

Disclosed is a method and system for playing and editing at least one video and audio file in real time. The system and method relates to a real-time video performance enhancing application, which enables a user to play one or multiple video and audio files in synchronization and during playback trigger manipulations and effects on the video and audio files using a graphical user interface.

### CROSS REFERENCE TO RELATED APPLICATION

This application claims the benefit of U.S. Provisional Application No. 62/376,708 filed on Aug. 18, 2016, and U.S. Provisional Application No. 62/442,979 filed on Jan. 6, 2017, which are incorporated by reference herein.

### FIELD OF INVENTION

The present invention relates to video editing, and more particularly to a computer based system and method for editing video/audio files in real time.

### BACKGROUND

Conventionally, stationary computers are used to perform video editing because the stationary computers are provided with computing resources compared to mobile devices. Such stationary computers can include desktop computers and servers. Users typically capture videos using their mobile devices because the mobile devices are more portable over stationary computers. Once users capture any digital content (e.g. video content) on their mobile devices, the captured digital content is then to be transferred from the mobile devices to the stationary computers for performing various operations on the captured digital content such as viewing or editing.

Many people record video on their mobile devices and share those videos with others. In many cases, these recorded videos could benefit from modifications that can alter the appearance of the video or improve visual and aural qualities of the video. Editing video content, however, can require considerable computing power and current technologies do not allow for meaningful video enhancements to be performed on computing devices in real time during playback.

Thus, in the light of the above mentioned problems, it is evident that, there is a need for a method and system which would enable a user to play one or multiple video and audio files in synchronization, and during playback, trigger manipulations and effects on the video and audio files using a graphical user interface.

### SUMMARY

It should be understood that this disclosure is not limited to the particular systems, and methodologies described herein, as there can be multiple possible embodiments of the present disclosure which are not expressly illustrated in the present disclosure. It is also to be understood that the terminology used in the description is for the purpose of describing the particular versions or embodiments only, and is not intended to limit the scope of the present disclosure.

It is an objective of the present invention to provide a method and system for playing and editing at least one video and audio file in real time. The method includes a step of receiving a first request, via a graphical user interface, for selecting and displaying a first video file in a first available channel, a step of receiving a second request, via the graphical user interface, for selecting and displaying second video file in a second available channel, a step of receiving a third request, via the graphical user interface, for selectively attaching at least one audio file to the first available channel or an additional video file in the first available channel or in the second available channel; a step of receiving at least one command, via the graphical user interface, for selectively performing predefined manipulation function associated with the command at a user defined time frame for customizing the first video in the first available channel, the second video in the second available channel and the at least one audio file during the playback.

Further, the method further includes a step of storing the customized first video in the first available channel, the customized second video in the second available channel and the customized audio file along with a manipulation data of the customized first video, the customized second video and the customized at least one audio file during playback, a step of receiving a mixing request, via the graphical user interface, for combining the customized first video, the customized second video and the customized at least one audio file for creating a final video based on the manipulation data, and a step of storing and displaying the final video in at least one master channel via the graphical user interface.

Another object of the present invention is to provide a real-time video performance instrument, which would enable a user to play one or multiple video and audio files in synchronization and during playback, splice and trigger manipulations and effects on the video and audio files using the graphical user interface.

Another object of the present invention is to provide the graphical user interface which allows a user to utilize an intensity lever to adjust the character and magnitude of each manipulation in real-time.

Another object of the present invention is to provide a method which is adapted to save and load manipulation data on new audio/video files. The manipulation data include a plurality of effects, manipulations, changes, and splices as performed on the previously saved audio/video files. Further, the method allows the user to utilize non-destructive recording, in such a manner that a customized file will be secured and safe in case of any system failure. This method further allows processing of each available video channel separately, including a master channel. The user can choose to use audio from the video output or an audio file. The user can record video or load video via the graphical user interface. The method further allows the user to record video at a special aspect ratio. The user can encapsulate the video with an audio-responsive waveform and resulting in generation of visualization effects for the encapsulated video.

Further, in some implementations, a computer readable storage medium is provided to store instructions causing a processing device to perform the operations described above.

For illustrative purposes, the description represented below is applicable to video data/video files, but the systems, apparatuses, and methods described herein can similarly be applied to any type of media content item, including audio data, visual data (e.g. images), audio-visual, or any combination thereof.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a complete understanding of the present invention, reference is now made to the following descriptions taken in conjunction with the accompanying drawing, in which:

FIG. 1 is a schematic block diagram and an overview of the real-time video performance enhancing system, according to the various embodiments of the present invention.

FIG. 2 is a flowchart on how real-time video performance enhancing application works, according to the various embodiments of the present invention.

FIG. 3 is an exemplary representation of a graphical user interface of the real-time video performance enhancing application, according to the various embodiments of the present invention.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

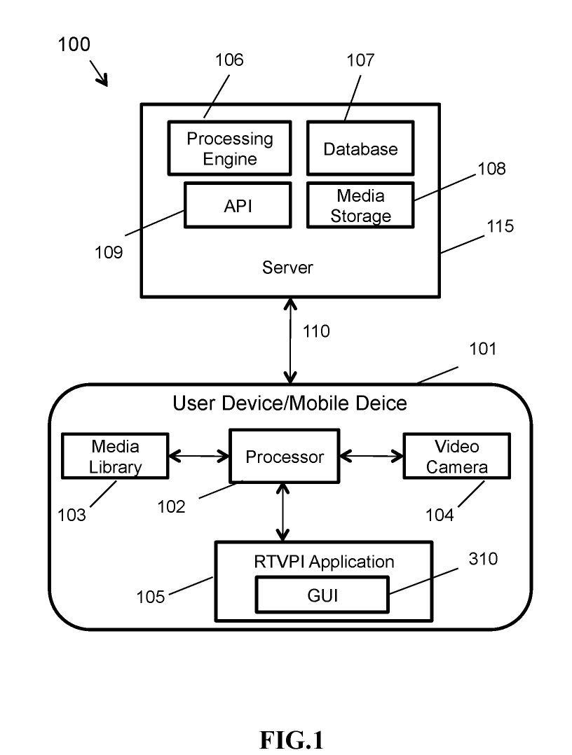

Some embodiments of this invention, illustrating all its features, will now be discussed in detail with respect to FIGS. 1-3.

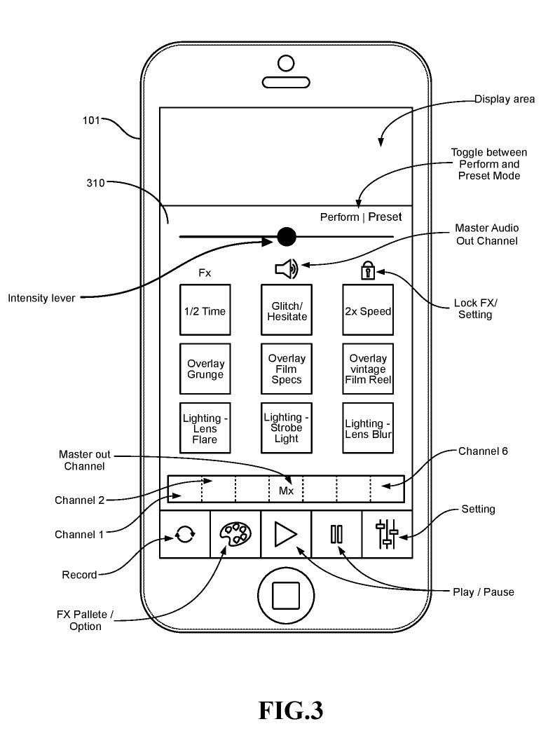

FIG. 1 illustrates example system architecture 100 that can include a plurality of mobile devices 101(although only one mobile device is shown illustrated). Each of the plurality of mobile device/user device 101 includes a processor 102, and media library 103 to store media files of different data types in a storage device of the mobile device 101 (not shown), a camera 104 and a Real Time Video Performance Instrument (RTVPI) application 105 having the graphical user interface 310 (as shown in FIG. 3). The system 100 further includes one or more servers 115 which includes a database 107, a media storage 108 and API (Application programming interface) 109 and processing engine module 106. The mobile device 101 and the server 115 are communicatively coupled to each other over a network 110. The network 110 connecting the mobile device 101 and the server 115 may be a public network (e.g., the Internet), a private network (e.g., a local area network (LAN) or wide area network (WAN)), or a combination thereof.

The mobile device 101 can be a portable computing device, such as, and not limited to, cellular telephones, personal digital assistants (PDAs), portable media players, notebooks, laptop computers, an electronic book reader or a tablet computer (e.g., that includes a book reader application), and the like. The mobile device 101 can receive a media item, such as a digital video or a digital movie from the database 107, or the media storage 108 or the media library 103. The mobile device 101 can run an operating system (OS) that manages hardware and software on the mobile device 101.

Media items can be received from any sources, including components of the mobile device 101, the server or server machine 115, another mobile device 101 etc and be stored in a storage unit. The storage unit comprises at least one of a database 107, the media storage 108, or the media library 103. For example, the storage unit can store a digital video captured by a video camera of a mobile device 101. The media storage 108 or the media library 103 can be a persistent storage that is capable of storing data. The persistent storage unit can be a local storage unit or a remote storage unit. The persistent storage units can be a magnetic storage unit, optical storage unit, solid state storage unit, electronic storage units (main memory), or similar storage unit. The persistent storage unit can be a monolithic device or a distributed set of devices. The term ‘set’, as used herein, refers to any positive whole number of items. The data storage can be internal to the mobile device 101 or external to the mobile device 101 and be accessible by the mobile device 101 via a network. As will be appreciated by those skilled in the art, in some implementations data storage may be a network-attached file server or a cloud-based file server, while in other implementations data storage might be some other type of persistent storage such as an object-oriented database, a relational database, and so forth.

The server/server machine 115 can be a rack mount server, a router computer, a personal computer, a portable digital assistant, a laptop computer, a desktop computer, a media center, a tablet, a stationary machine, or any other computing device capable of performing enhancements of videos.

The present invention provides a method which can be executed by a real-time video performance apparatus having a processor executable application stored in the memory. The application enables a user to play one or multiple video and audio files in synchronization and during playback, splice and trigger manipulations and effects on the video and audio files using the graphical user interface 310. The method includes a step of receiving a first request, via the graphical user interface 310, for selecting and displaying a first video file in a first available channel, a step of receiving a second request, via the graphical user interface 310, for selecting and displaying second video file in a second available channel, a step of receiving a third request, via the graphical user interface 310, for selectively attaching at least one audio file to the first and second video file in the first available channel and in the second available channel, a step of receiving at least one command, via the graphical user interface 310, for selectively performing predefined manipulation function associated with the command at a user defined time frame for customizing the first video in the first available channel, the second video in the second available channel and the at least one audio file during playback.

Further, the method includes a step of storing the customized first video in the first available channel, the customized second video in the second available channel and the customized audio file along with a manipulation data of the customized first video, the customized second video and the customized at least one audio file during playback, a step of receiving a mixing request, via the graphical user interface 310, for combining the customized first video, the customized second video and the customized at least one audio file for creating a final video based on the manipulation data, and a step of storing and displaying the final video in at least one master channel via the graphical user interface 310.

In one embodiment of the present invention, the first available channel, the second available channel and the at least one master channel includes the respective windows showing the first video, the second video, and the final video respectively along with their respective timeline in the graphical user interface 310. Further, the first video, the second video, and at least one audio file are received from a media library stored in the memory or online audio/video streaming server or camera in real time.

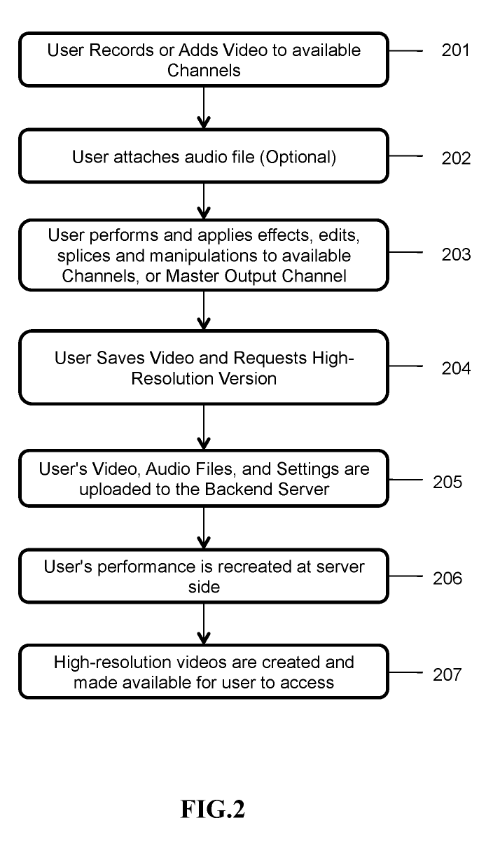

FIG. 2 illustrates a flow chart showing the workflow of the mobile application. As shown in the FIG. 2, at step 201 the graphical user interface 310 (as shown in FIG. 3) allows a user to record or insert one or more video files to one or more available channels such as channel 1, channel 2 . . . channel 6. After recording or insertion of the video files, the graphical user interface 310 allows the user to provide at least one audio file to at least one available channel as shown at step 202. Thereafter, as shown at step 203, the graphical user interface 310 allows the user to perform and apply at least one of a plurality of effects, edits, splices, or manipulations to the available channels, or master channel by sending manipulation command via at least one graphical user interface button for performing at least one manipulation. Upon receiving a selection from the user at the step 203 which trigger manipulation command, the user saves the customized video at the user computing device and requests a high-resolution version of the saved video as shown at step 204. At step 205, the graphical user interface sends the request along with the saved user's video, audio files, the manipulation data and settings to the server. The server sends the received video to the processing engine which is adapted to recreate the performance of the user's video based on the manipulation data as shown at step 206. Further, at step 207, the processing engine creates high-resolution videos and allows the user to access the high-resolution video via the graphical user interface 310 through the media storage 108.

FIG. 3 illustrates a graphical user interface 310 of the application 105 which is executed by the processor to perform various video playback or editing functions. The graphical user interface 310 includes a video display area which is adapted to show or play at least one video file selected by the user form channel 1-6. Further, the video display area can display one or more video files simultaneously. The graphical user interface 310 includes one or more graphical user interface buttons/filters which are configured to trigger at least one command. The commands assigned to the one or more graphical user interface buttons/filters for performing at least one manipulation function. The manipulation function, for example, comprises an operation intended to augment, alter, or modify the objective quality or subjective artistic value of the video files. For performing manipulation functions a plurality of modification options are provided to the user. In another embodiment, the user can customize the provided options to create new options. Modification includes, but not limited to, applying filtration that may modify the appearance of the video. Filters can adjust or augment colors, saturation, contrast, brightness, tint, focus, and exposure and can also add effects (FX) such as framed borders, color overlay, blur, sepia, lens flares, etc. Other modifications can be spatial transformations, such as cropping or rotation that can alter a spatial property of the video, such as size, aspect ratio, height, width, rotation, angle, etc. Other modifications can be simulations of photographic processing techniques (e.g., cross process, high dynamic range (HDR), HDR-ish), simulation of particular cameras models, or the styles of particular photographers/cinematographers. Examples of static modifications may include cross process, cinemascope, adding audio and a mix level for the audio, erasure of specific audio (e.g., removing a song from the video recording), or addition of sound effects, etc. Examples of dynamic modifications can include identifying filters and randomizing inputs (e.g. intensity of effect) over course of the video, filters using inferred depth map info (e.g., foreground color with the background black & white, foreground in focus with background blur), speed up, slow down, tilt-shift simulation, adding a frame outside the video (e.g., video inside an old TV with moving dials), superimposing things on top of video, blending multiple videos together such as through additive, subtractive or multiplication blend methods, audio-responsive manipulations, overlaying items on people's faces (e.g. hats, mustaches, etc) that can move with the people in the video, selective focus, miniature faking, tilted focus, adjusting for rotation, 2D to 3D conversion, etc,

In another embodiment of the present invention, as shown in FIG. 3, the graphical user interface 310 allows a user to utilize an intensity lever/slide bar to adjust the character and magnitude of each manipulation in real-time.

In another embodiment of the present invention, the software application having the graphical user interface 310 allow the user to save and load manipulation data on new audio/video file. The manipulation data include the effects, manipulations, changes, and splices as performed on the previously saved audio/video file. Further, the method allows the user to utilize non-destructive recording, so that customized file will be secured and safe in case of any system failure. The method further allows each video available channel to be processed separately, including the master channel. The user can choose to use audio from the video output or an audio file. The user can record video or load video via the graphical user interface 310. The method allows the user to record video at a special aspect ratio. The method allows the user to encapsulate the video with audio-responsive waveform visualization.

In an exemplary embodiment of the present invention, the user would first add or record audio or video to each respective channel and align each audio/video element in a specified timeline where desired. To create FX, the user would select a channel to process and trigger the play button at which all video and audio would start playing in synchronization. The user can utilize the graphical user interface to trigger effects and manipulations, which would then be recorded and stored during real-time playback, the effects and manipulations would be triggered to the appropriate channel at the precise time and durations that they were triggered. The user can continue to layer and record multiple FX by repeating this process. This FX and manipulations can be applied to both a single channel, as well as the master channel (if the master output channel (master channel) is selected during playback). For example, the user may be able to add different effects to channel, and then add additional effects to the master output channel.

In an exemplary embodiment of the present invention, the RTVPI application 105 is adapted to show the real time progress during playback and output one or more videos which are processed in one or more video channels via the graphical user interface 310.

In order to choose which channels should feed into the master channel, the user would select the master channel by tapping on the channel labeled (not shown explicitly) as such in the wireframe, trigger the play button, and then in real-time during playback, tap the visual interface for channels 1-6 as desired, similar to how effects and manipulations are applied. In an exemplary embodiment the user can select channel 1 during minute 1, channel 4 during minute 2 and so on. The channels can be selected at any instant of time by the user as desired. The time instant may be represented for example in minutes.

In another implementation of the present invention, a computing system within which a set of instructions, for causing the machine to perform one or more of the methodologies discussed herein may be executed. The machine may be connected (e.g., networked) to other machines in a local area network (LAN), an intranet, or an extranet. The machine may operate with a server or a client machine in a client-server network environment, or as a peer machine in a peer-to-peer (or distributed) network environment. The machine may be a personal computer (PC), a tablet PC, a personal digital assistant (PDA), a cellular telephone, a web appliance, a server, a network router, or any machine capable of executing a set of instructions (sequential or otherwise) that specify actions to be taken by that machine. Further, the term “machine” shall also be taken to include any collection of machines that individually or jointly execute a set (or multiple sets) of instructions to perform any one or more of the methodologies discussed herein.

Additionally, as will be appreciated by those skilled in the art, the machine may include an image sensing module, an image capture device, a hardware media encoder/decoder and/or a graphics processor (GPU). The image sensing module can include an image sensor (Camera for example) capable of converting an optical image or images into an electronic signal.

Further as used herein, the term “data storage” or any variations thereof may include a machine-readable storage medium (or more specifically a computer-readable storage medium) having one or more sets of instructions ((e.g., RTVPI (real time video performance Application 105 having the graphical user interface 310)) embodying any one or more of the methodologies or functions described herein. Further, the video preview module may also reside, completely or at least partially, within main memory and/or within processing device during execution thereof. As would be appreciated by those skilled in the art, the main memory and processing device also constitutes machine-readable storage media.

For simplicity of explanation of implementation, the methods have been described as a series of steps. However, the steps in accordance with this disclosure can occur in various orders and/or concurrently, and with other steps not presented and described herein. Furthermore, not all illustrated steps may be required to implement the methods in accordance with the disclosed subject matter. In addition, those skilled in the art will understand and appreciate that the methods could alternatively be represented as a series of interrelated events. Additionally, it should be appreciated that the methods disclosed in this specification are capable of being stored on an article of manufacture (e.g., a computer readable storage medium) to facilitate transporting and transferring such methods to computing devices. The term article of manufacture, as used herein, is intended to encompass a computer program accessible from any computer-readable device or storage media.

The methods and systems described herein can be used in a wide variety of implementations, including as part of a mobile application (“app”), and can be part of a photo or video-related software including a mobile operating system. Applications installed on the mobile device can access the systems and methods via one or more application programming interface (API).

It will finally be understood that the disclosed embodiments are presently preferred examples of how to make and use the claimed invention, and are intended to be merely explanatory. Reasonable variations and modifications of the illustrated examples in the foregoing written specification and drawings are possible without departing from the scope of the invention as defined in the claim below.

What is claimed is:

1. A computer-implemented method for playing and editing at least one video and audio file in real time, comprising:
receiving a first request, via a graphical user interface, for selecting and displaying a first video file in a first available channel;
receiving a second request, via the graphical user interface, for selecting and displaying a second video file in a second available channel;
receiving a third request, via the graphical user interface, for selectively attaching at least one audio file to the first available channel or an additional video file in the first available channel or in the second available channel;
receiving at least one command, via the graphical user interface, for selectively performing manipulation function associated with the command at a user defined time frame for customizing the first video in the first available channel, the second video in the second available channel and then at least one audio file during playback;
storing the customized first video in the first available channel, the customized second video in the second available channel and the customized audio file along with a manipulation data of the customized first video, the customized second video and the customized data of at least one audio file during playback;
receiving a mixing request, via the graphical user interface, for combining the customized first video, the customized second video and the customized data of at least one audio file for creating a final video based on the manipulation data; and
storing and displaying the final video in at least one master channel via the graphical user interface.

2. The method as in claim 1, wherein the first available channel, the second available channel and the at least one master channel includes the respective windows showing the first video, the second video and the final video respectively along with their respective timeline in the graphical user interface.

3. The method as claimed in claim 1, wherein the first video, the second video and at least one audio file is received from a media library stored in the memory.

4. The method as claimed in claim 1, wherein the first video, the second video and at least one audio file is received online from an audio/video streaming server.

5. The method as claimed in claim 1, wherein the first video, the second video and at least one audio file is received from audio/video stream recorded from the camera in real time.

6. The method as claimed in claim 1, wherein the graphical user interface includes one or more graphical user interface buttons which trigger at least one command for performing the manipulation function.

7. The method as claimed in claim 1, wherein the graphical user interface allows a user to utilize an intensity lever to adjust the character and magnitude of each manipulation in real-time.

8. The method as claimed in claim 1, wherein the graphical user interface includes one or more graphical user interface buttons which allows the user to encapsulate the video with an audio-responsive waveform.

9. The method as claimed in claim 1, further comprising uploading the final video to a server via network communication, wherein the server is adapted to change the video into a high-resolution video and enable users to access the high-resolution video via the graphical user interface.

10. A system for playing and editing at least one video and audio file in real time, comprising:
one or more processors; and
a non-transitory computer readable medium for storage of a plurality of instructions, which when executed by the one or more processors, causes the one or more processors to perform operations comprising of:
receiving a first request, via a graphical user interface, for selecting and displaying a first video file in a first available channel;
receiving a second request, via the graphical user interface, for selecting and displaying a second video file in a second available channel;
receiving a third request, via the graphical user interface, for selectively attaching at least one audio file to the first available channel or an additional video file in the first available channel or in the second available channel;
receiving at least one command, via the graphical user interface, for selectively performing manipulation function associated with the command at a user defined time frame for customizing the first video in the first available channel, the second video in the second available channel and the at least one audio file during playback;
storing the customized first video in the first available channel, the customized second video in the second available channel and the customized audio file along with a manipulation data of the customized first video, the customized second video and the customized data of at least one audio file during playback;
receiving a mixing request, via the graphical user interface, for combining the customized first video, the customized second video and the customized data of at least one audio file for creating a final video based on the manipulation data; and
storing and displaying the final video in at least one master channel via the graphical user interface.
